(19) United States
(12) Patent Application Publication
(10) Pub. No.: US 2010/0055638 A1
(43) Pub. Date: Mar. 4, 2010

(54) SUPPLY SYSTEM FOR TOOTH SAMPLES

(75) Inventors: Olivia Albarski, Aarau (CH); Norbert Thiel, Bad Sackingen (DE)

Correspondence Address: Clements Bernard PLLC, 1901 Roxborough Road, Suite 250, Charlotte, NC, 28211, US

(73) Assignee: VITA ZAHNFABRIK H. RAUTER GMBH & CO. KG, Bad Säckingen (DE)

(21) Appl. No.: 12/523,748

(22) PCT Filed: Dec. 13, 2007
(86) PCT No.: PCT/EP07/63875

§ 371 Date: Jul. 20, 2009

(30) Foreign Application Priority Data
Jan. 25, 2007 (EP) 07101150.6

(51) Int. Cl. A61C 19/10

(52) U.S. Cl. 433/26

(57) ABSTRACT

A supply system for tooth samples for determining brightness, chroma and/or shade of natural and/or bleached teeth, has a plurality of receiving elements (20, 22) in which a plurality of tooth samples (30) are linearly disposed. Groups of tooth samples (30) are provided next to each other in a first receiving element (20), wherein the tooth samples (30) have the same brightness and the same shade within each group. The second receiving element (22) also has groups of tooth samples (30) that are disposed next to each other, wherein tooth samples (30) are disposed having the same brightness and different shades within each group.

The invention refers to a supply system for tooth samples for determining the brightness, the chroma and/or the shade of natural and/or bleached teeth.

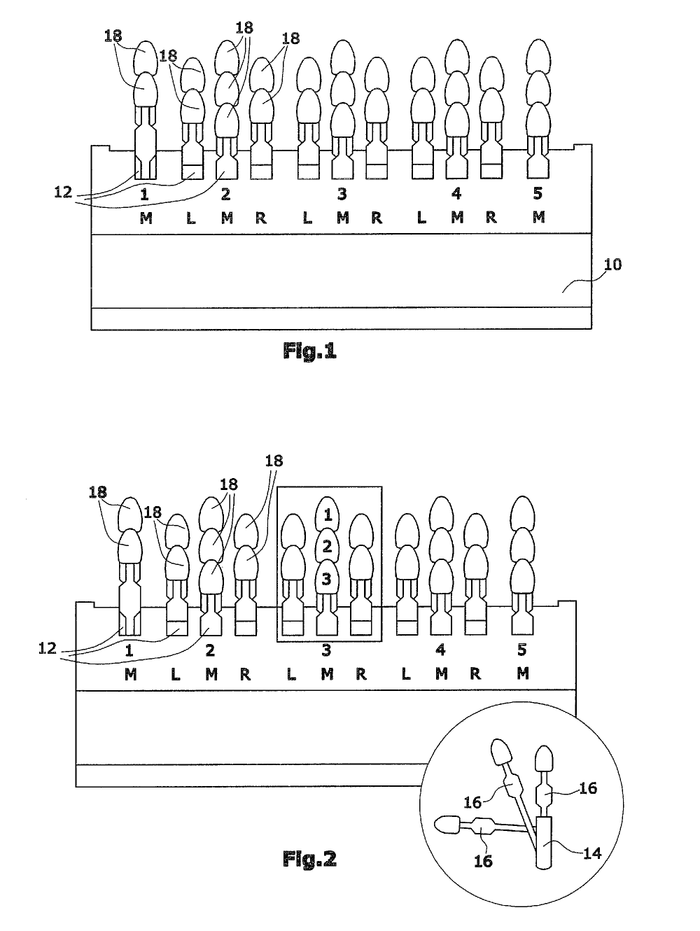

Based on the criteria concerning the brightness, the chroma and the shade of human teeth, described in U.S. Pat. No. 5,498,157, the applicant has developed a supply system for tooth samples designated as VITA Toothguide 3D-Master. The supply system Toothguide 3D-Master is illustrated in FIGS. 1-3. A receiving element 10 is provided with a plurality of slots 12, with a sample holder 14 being inserted in each slot 12 (FIG. 2). The sample holder 14 holds two or three sample pins 16 held pivotally in the sample holder 14. Determining the brightness, the chroma and the shade is done in three steps illustrated in FIGS. 1, 2 and 3. For this purpose, the individual tooth samples 18 are assigned to different groups, depending on their brightness, their chroma and their shade. In the groups 1-5 (FIG. 1), each group is comprised of tooth samples 18 having the same brightness. Within the groups 1-5, the tooth samples differ in chroma and shade. In each individual group, as for instance in the group 3 marked in FIG. 2, each sample holder 14 includes two or three tooth samples of identical shade, but different chroma. Except for the two marginal groups 1 and 5, each brightness group includes three sample holders. The different shades make the difference between these. The central sample holder M has a medium shade, the left sample holder 14 identified by the letter L has a somewhat yellowish shade, and the right sample holder 14 identified by the letter R has a somewhat reddish shade (FIG. 3).

In the determination of the brightness, the chroma and the shade of a natural or a bleached tooth, the brightness is determined in a first step (FIG. 1). In doing so, the dentist or the dental technician selects one of the brightness groups 1-5. After the selection of the brightness group, the chroma is then selected within the brightness group (FIG. 2). This is done by pulling the central sample holder 14 from the corresponding brightness group (FIG. 2). Then, the individual sample pins are pivoted so that the tooth samples can be held next to the teeth of the patient for a determination of the chroma designated as 1, 2 or 3. In the next step (FIG. 3) it is determined, with reference to a medium shade M, whether the shade of the tooth is rather yellowish (I) or reddish (R).

Although the VITA Toothguide 3D-Master allows for a very exact determination of the brightness, the chroma and the shade of a tooth, it has shown that the handling is difficult. For instance, it is difficult to exactly determine the brightness group in the first step if the tooth color to be determined is very chromatic. This is due to the fact that the human eye only has a limited ability to differentiate between brightness and chroma and that it compensates one for the other. Chromatic colors are thus perceived as darker. This may result in a wrong degree of brightness being selected in the first step. This error can not be corrected in the subsequent steps.

It is an object of the present invention to provide a supply system for tooth samples for the determination of the brightness, the chroma and/or the shade that is simple to handle and allows to exactly determine the brightness, the chroma and/or the shade with a high reliability.

The object is achieved with a supply system as defined in claim 1, 6 or 9.

An essential element of the invention is the simplification of the supply system. This is achieved by providing individual receiving elements in which the individual tooth samples are arranged only in linear array. Here, preferably, no plurality of sample pins, each carrying a tooth sample, is connected, e.g. pivotally, with a sample holder, as is the case with the 3D-Master. Rather, the individual tooth samples, for instance those fastened on respective sample pins, are broken up. According to the invention, the tooth samples are arranged singly and side by side, i.e. linearly, in one row. Thus, the optical clarity is drastically improved. According to the invention, the supply system in the different embodiments of the invention, respectively comprises a plurality of receiving elements. The individual receiving elements are used one after the other to determine the brightness, the chroma and/or the shade. As a result, the number of tooth samples to be considered in one determination step is drastically reduced.

A first preferred embodiment of the supply system comprises two receiving elements. A first receiving element has a plurality of tooth sample groups arranged side by side. The tooth samples arranged in one group have the same brightness and the same shade. Using the first receiving element, it is thus readily possible in a first step to determine the brightness group. This is possible in a simple manner in particular when using the medium chroma degree since each group preferably comprises a maximum of three tooth samples. After the brightness group has been determined, the chroma can be determined within the corresponding group. For the determination of the shade, a second receiving element is provided which can be used independent of the first receiving element. The second receiving element in turn comprises a plurality of tooth sample groups arranged side by side. Within each group, the tooth samples have the same brightness, but different shades. Further, even a fine grading of the chroma can be provide within the individual groups. Here, the second receiving element may comprise two groups per degree of brightness. One of the groups includes more yellowish shades, while the other includes more reddish shades.

Since the individual tooth samples, which are in particular held by sample pins, are preferably removable from the receiving elements, especially by pulling them out, it is possible to take the tooth sample selected in the first and second step from the first receiving element and to hold it next to the tooth samples of the second receiving element for a better comparison of both. Further, removing the individual tooth samples allows to hold the same immediately to the tooth of a patient.

The first embodiment of the invention is preferably developed such that, for a further simplification of the first step, i.e. for the determination of the brightness, an additional third receiving element is provided. This receiving element comprises tooth samples of different brightness, with only one tooth sample being preferably provided per degree of brightness. Here, preferably all tooth samples arranged in the third receiving element are of an identical shade, especially a medium shade, and or of an identical chroma, especially a medium chroma. When the brightness has been determined using the third receiving element, the chroma and the shade are determined as described above.

In a second embodiment of the invention the third receiving element, which in particular has only one tooth sample per degree of brightness, is combined with a fourth receiving element into a supply system. Here, the fourth receiving element includes a plurality of brightness groups of tooth samples, the tooth samples in each group being comprised into tooth samples of identical brightness. Preferably, an order of tooth samples is defined within this brightness group with respect to the chroma and the shade.

In a third embodiment of the invention, as in the other embodiments, a plurality of receiving elements is provided in which a plurality of tooth samples is arranged only linearly, i.e. side by side. A receiving element, referred to as the fifth receiving element to avoid confusion, includes a plurality of tooth sample groups, the chroma of the tooth samples being identical within each group. Preferably, all groups have an identical, especially a medium shade. Within each group, the respective brightness of the tooth samples vary, these being ordered preferably from light to dark. A second receiving element of this embodiment corresponds to the second receiving element for determining the shade, which has been described in the context of the first embodiment.

Thus, the invention has the specific advantage of a reduction to a linear realization. Thereby, a dentist is provided with a familiar linear arrangement of the color scale, however, offering the possibility of an improved and more accurate selection with respect to the brightness, the chroma and/or the shade.

The following is a detailed description of the invention with reference to preferred embodiments.

In the Figures:

FIGS. 1-3 schematic top plan views on the product VITA Toothguide 3D-Master according to prior art,

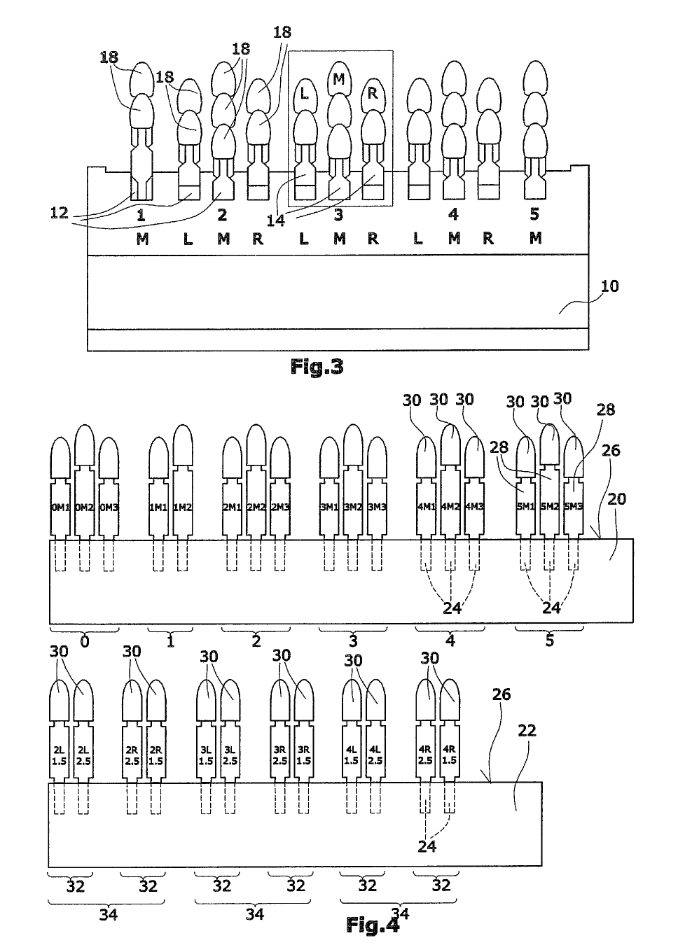

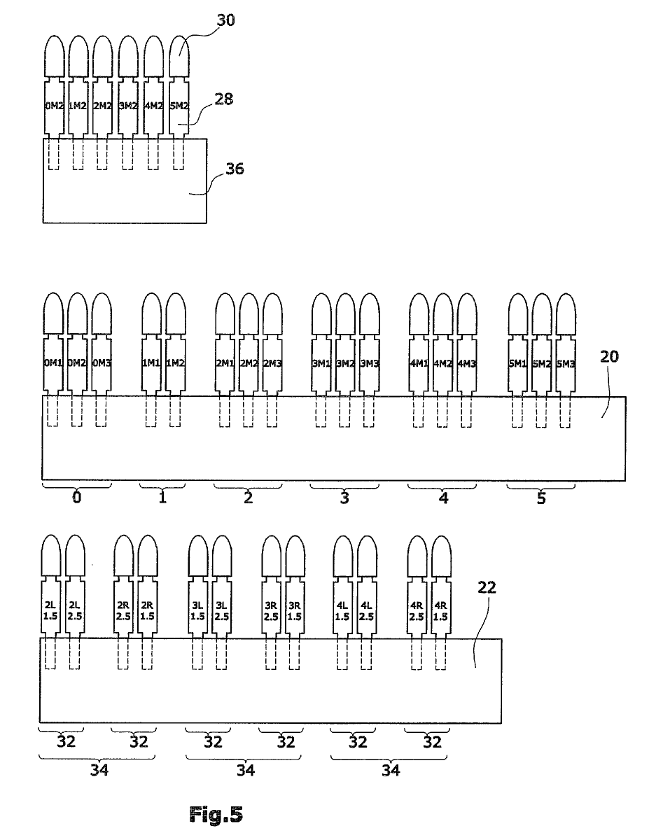

FIG. 4 a schematic top plan view on a first preferred embodiment of the supply system,

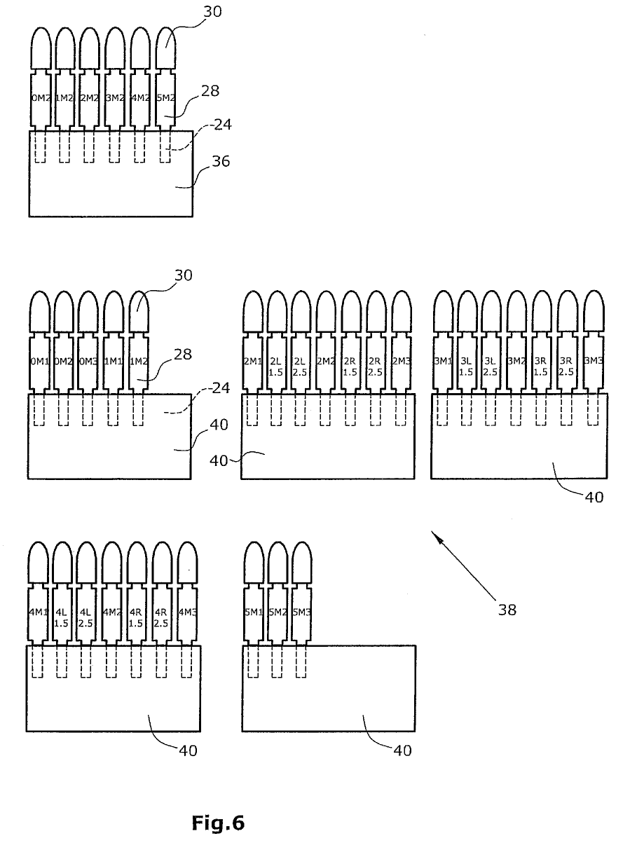

FIG. 5 a schematic top plan view on an extension of the first embodiment,

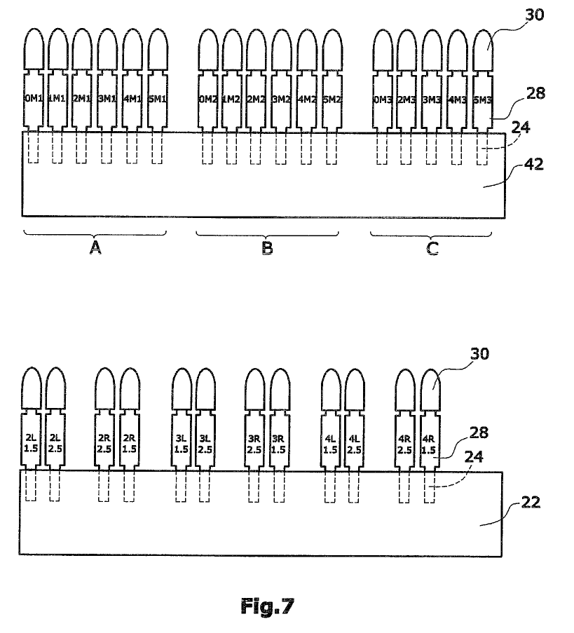

FIG. 6 a schematic top plan view on a second preferred embodiment of the supply system,

FIG. 7 a schematic top plan view on a third preferred embodiment of the supply system.

In a first preferred embodiment (FIG. 4) of the supply system of the present invention, a first receiving element 20 ad a second receiving element 22 are provided. The substantially cuboid-shaped receiving elements 20, 22 have insertion slots 24 open at a top 26. Sample pins 28 are inserted into the insertion slots 24 such that they can be pulled out, each sample pin 28 carrying a tooth sample 30. All tooth samples 30 differ from each other either in brightness, chroma and/or shade.

In the first described embodiment (FIG. 4), the first receiving element comprises a plurality of groups numbering from 0-5. Within each group, the tooth samples 30 have the same brightness, i.e. the brightness 0, 1, 2, 3, 4, or 5. In the embodiment illustrated all tooth samples arranged in the first receiving element 20 have the same shade M. Within the different brightness groups 0-5, the tooth samples 30 have different chromas 1, 2 or 3. The colors 0M1-0M3 are colors outside the natural color range of teeth and caused by bleaching teeth.

The second receiving element 22 comprises six different groups 32 o tooth samples which in the preferred embodiment illustrated each comprise two tooth samples 30. Each individual group 32 comprises tooth samples of an identical shade, either the shade L or the shade R. Within the individual groups 32, the tooth samples further have the same brightness, wherein two respective groups 32 may be comprised into one main group 34 so that the same brightness exists within the main group 34. Within the individual groups 32, the tooth samples 30 have different chromas, with the embodiment illustrated showing intermediate degrees 1.5 and 2.5.

For a selection of the brightness, the chroma and the shade, a dentist or a dental technician will first select one of the degrees of brightness 1-5, using the first receiving element 20. Then, the dentist chooses the chroma 1, 2 or 3 within the degree of brightness. Thereafter, using the second receiving element 22, the shade is selected, employing a respective main group 34 in dependence on the brightness found before. Possibly, the receiving element 22 may be divided into several receiving sub-elements, wherein each receiving sub-element preferably comprises a main group 34. This facilitates the handling, since only the corresponding receiving sub-element is needed to determine the color complex.

In the extension of the first embodiment, illustrated in FIG. 5, a third receiving element 36 is provided in addition to the receiving elements 20, 22. The third receiving element 36, in the embodiment illustrated, includes six sample pins 28, each carrying a tooth sample 30. The six tooth samples exclusively differ in brightness and are arranged linearly side by side by degrees of brightness 0-5. To allow for a determination of brightness that is as exact as possible, the six tooth samples have an identical chroma 2 as well as an identical shade M.

In a step prior to the steps described for FIG. 4, the dentist or dental technician will thus first determine the brightness using the third receiving element 36. Subsequently, with reference to the corresponding degree of brightness 0-5, the chroma can be determined using the first receiving element 20. Here, in the embodiment illustrated in FIG. 5, the receiving element 20 can be divided into a plurality of receiving sub-elements, with each receiving sub-element then comprising a brightness group.

In the second preferred embodiment of the supply system according to the invention (FIG. 6), and analogous with embodiments described in the context of FIGS. 4 and 5, again, individual sample pins 28, each carrying tooth samples 30, are set into receiving elements and are removable therefrom. For a determination of brightness, the third receiving element 36 of the embodiment of the supply system illustrated in FIG. 6 is provided in analogy with the one described for FIG. 5.

The additional receiving element provided in this embodiment, i.e. the fourth receiving element 38, is divided into several receiving sub-elements 40 in the embodiment illustrated. Each individual receiving sub-element 40 comprises a group of tooth samples 30. Except for the first group in which the two degrees of brightness 0 and 1 are comprised, each group exclusively includes tooth elements of the same degree of brightness. Within a degree of brightness, tooth samples of different chromas and different shades are provided. In the preferred embodiment, these are sorted, the shades L or R being arranged, respectively, between the tooth samples 30 with the chromas 1, 2 or 3. In the embodiment illustrated, two tooth samples 30 of the shade L or the shade R are provided, respectively, indicating a value of the intermediate chroma, i.e. 1.5 and 2.5.

The first group is an exception, the shades L and R not being provided therein. This group exclusively contains comprised tooth samples of the brightness 0 and 1 in connection with different chromas. It should be noted here that the natural tooth color scale is largest in the range of medium brightness. In the ranges of very great brightness or very low brightness, the scale is narrower. Moreover, the medium degrees of brightness appear more frequently, whereas very great and very low degrees of brightness are clearly less frequent. Therefore, in the brightness group 1 and 5, M colors are an acceptable compromise. “1M3” is outside the natural tooth color scale. Another exception is formed by the last group, the brightness group 5. Here, no tooth samples of different shades are included either.

Also in the third embodiment (FIG. 7), the individual sample pins 28, each carrying a single tooth sample 30, are set into insertion slots 24.

In this embodiment of the supply system two receiving elements are again provided. The receiving element used first is the fifth receiving element 42. the receiving element carries a plurality of tooth sample groups, with the tooth samples in the individual groups A, B, C having the same chroma 1, 2, 3. Within the individual groups A, B, C, the tooth samples 30 differ in their degree of brightness 0-5. All tooth samples of the fifth receiving element 42 have the same medium shade. Using the fifth receiving element 42, the brightness and the chroma are determined. Here, it is up to the dentist or the dental technician whether he wishes to determine the brightness or the chroma first. For example, he may first determine the chroma, i.e. select one of groups A, B, C, and then determine the brightness within the respective group. It is also possible, for instance, to first determine the brightness 0-5 using the intermediate chroma group B and to then check whether the chroma of degree 1 or 3 is more fitting.

The further receiving element provided in this embodiment of the present supply system is the receiving element 22 (FIG. 4).

1-14. (canceled)

15. A supply system for tooth samples for the determination of the brightness, the chroma and/or the shade of natural and/or bleached teeth, comprising
a plurality of receiving elements for a linear arrangement of a plurality of toot samples,
wherein a first receiving element comprises groups of tooth samples arranged side by side, and the tooth samples within each group have the same brightness and the same shade, and
wherein the second receiving element comprises groups of tooth samples arranged side by side, and tooth samples of the same brightness and different shades are arranged in each of said groups.

16. The supply system of claim 15, characterized in that all tooth samples arranged in the first receiving element have the same shade, in particular a medium shade, but different chromas.

17. The supply system of claim 15, characterized in that the second receiving element comprises two groups per degree of brightness, in particular a group with more yellowish shades and a group with more reddish shades, the chroma being graduated within the group.

18. The supply system of claim 15, characterized by a third receiving element comprising tooth samples of different degrees of brightness.

19. The supply system of claim 18, characterized in that the tooth samples arranged in the third receiving element have an identical shade and/or an identical chroma.

20. A supply system for tooth samples for the determination of the brightness, the chroma and/or the shade of natural and/or bleached teeth, comprising
a plurality of receiving elements for a linear arrangement of a plurality of tooth samples,
wherein a third receiving element with tooth samples of different degrees of brightness is provided, and
wherein a fourth receiving element comprises a plurality of groups of tooth samples and each group includes tooth samples of identical brightness, but different shade and/or different chroma.

21. The supply system of claim 20, characterized in that the fourth receiving element comprises at least one, preferably three groups, and that the tooth samples are sorted within the groups.

22. The supply system of claim 20, characterized in that, in the fourth receiving element, two degrees of brightness, in particular the degrees of brightness 0 and 1, are comprised in one group.

23. The supply system of claim 20, characterized in that, in the fourth receiving element, single brightness groups include no tooth samples that vary in shade.

24. A supply system for tooth samples for the determination of the brightness, the chroma and/or the shade of natural and/or bleached teeth, comprising
a plurality of receiving elements for a linear arrangement of a plurality of tooth samples,
wherein a fifth receiving element comprises a plurality of groups of two elements with identical chroma, and
wherein a second receiving element comprises groups of tooth samples arranged side by side, and tooth samples of the same brightness and different shades are arranged in each of said groups.

25. The supply system of claim 24, characterized in that the fifth receiving element exclusively comprises tooth samples of an identical shade, especially a medium shade.

26. The supply system of claim 24, characterized in that the fifth receiving element includes in each group tooth samples of different degrees of brightness, especially sorted by the degree of brightness.

27. The supply system of claim 15, characterized in that at least one receiving element is divided in receiving sub-elements each receiving sub-element in particular including one group of tooth samples.

28. The supply system of claim 27, characterized in that a receiving sub-element comprises two groups of different shades, but of the same degree of brightness.
